(19) United States
(12) Patent Application Publication
(10) Pub. No.: US 2003/0003364 A1
(43) Pub. Date: Jan. 2, 2003

(54) Lithium secondary battery with an improved negative electrode structure and method of forming the same

(75) Inventors: Mitsuhiro Mori, Tokyo (JP); Kouji Utsugi, Tokyo (JP); Hironori Yamamoto, Tokyo (JP); Jiro Iriyama, Tokyo (JP); Tamaki Miura, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/170,702

(22) Filed: Jun. 14, 2002

(30) Foreign Application Priority Data
Jun. 14, 2001 (JP) 2001-180710

(51) Int. Cl. H01M 4/58

(52) U.S. Cl. 429/231.95; 429/212; 429/232; 429/231.4; 29/623.2

(57) ABSTRACT

A lithium secondary battery includes: a positive electrode; and a negative electrode, which further includes a lamination structure comprising: a lithium ion supporting layer capable of supporting lithium ions; and an amorphous-state lithium-based layer in contact directly with the lithium ion supporting layer.

### BACKGROUND OF THE INVENTION

1. Field of the Invention

The present invention relates to a lithium secondary battery and a method of forming the same, and more particularly to a lithium secondary battery having a negative electrode including a lithium metal as an active material, and a method of forming the same.

2. Description of the Related Art

It has been known to ones skilled in the art that a non-aqueous electrolyte lithium secondary battery having a negative electrode including a lithium metal as an active material is not only advantageous in a high energy density and a large electromotive force but also disadvantageous in allowing dendrite crystal to be grown on a surface of the lithium metal of the negative electrode. In worst case, the grown dendrite crystal may project through a separator and reach a positive electrode, resulting in a short circuit formation via the grown dendrite crystal between the negative and positive electrodes. This short circuit formation not only the battery dysfunctional but also causes abnormal chemical reaction and normal heat generation, which give rise to a problem with a safety of the battery and also a possible deterioration in cyclic characteristic of the battery.

In order to suppress the crystal growth of dendrite on the surface of the lithium metal, a uniform distribution of lithium ions over the surface of the negative electrode is effective. In order to obtain such a desirable uniform distribution of lithium ions, it is effective to provide a layer which has a uniform lithium ion concentration on an interface between the lithium metal of the negative electrode and the electrolyte.

Alternatively, it was in the past proposed for suppressing the dendrite growth that the lithium metal is mixed with other metal such as aluminum, bismuth, lead, or indium to form an alloy, or that an oxide layer is formed on the surface of the lithium metal of the negative electrode.

The above conventional proposals are, however, disadvantageous in lower operational voltage and lower energy density as compared to when the negative electrode comprises the lithium metal.

Further, alternatively, Japanese laid-open patent publication No. 7-296812 discloses that in place of a lithium metal foil, an amorphous lithium layer or an amorphous lithium alloy layer is formed on the surface of the negative electrode, wherein the amorphous layer makes it difficult to form active points such as crystal grains serving as singular points for the growth of the dendrite crystal. It was, however, confirmed that the formation of the amorphous layer is insufficient for obtaining desirable performances and characteristics of the battery.

Moreover, Japanese laid-open patent publication No. 6-36800 discloses that a porous insulating film is evaporated on the lithium metal negative electrode. It was, however, confirmed that the formation of the porous insulating film makes it difficult to control the uniform thickness of the porous insulating film and also control distribution of the lithium ions.

Still more, Japanese laid-open patent publication No. 2001-076710 discloses that a semiconductor film is formed on the metal, wherein the semiconductor film is in contact with the electrolyte. An undesirable reduction reaction is caused with decomposing the electrolyte with the electron conductivity such as tetracyanoquinodimethane. This makes it difficult to keep a high efficiency for a long time.

Yet more, Japanese laid-open patent publication No. 59-31570 discloses a solid state thin film lithium secondary battery which includes a lithium-containing solid state electrolyte thin film.

Also, Japanese laid-open patent publication No. 5-266894 discloses a battery having such a lamination structure that a solid-state electrolyte layer is sandwiched between negative and positive electrode layers, each of which includes a lithium metal or a lithium alloy as active material.

Also, Japanese laid-open patent publication No. 6-223820 discloses a lithium secondary battery having a lithium-ion conductive polymer film formed on the surface of the lithium electrode by a plasma enhanced chemical vapor deposition process.

Also, Japanese laid-open patent publication No. 6-290773 discloses an amorphous lithium metal layer formed on the surface of the negative electrode.

Also, Journal of Electrochem. Society vol. 143, p 3208, (1996) discloses a glass-state electrolyte formed on the lithium metal by a vacuum evaporation. Similarly, U.S. Pat. No. 5,314,765 discloses the formation of the glass-state electrolyte on the lithium metal by the vacuum evaporation. These conventional techniques are, however, disadvantageous in that a non-uniform oxide film on the surface of the lithium metal makes it difficult to obtain a desirable uniformity of the glass-state electrolyte film on the lithium metal.

In addition, Japanese laid-open patent publications Nos. 9-199180 and 10-144295 disclose evaporation of lithium on a carbon plate. These conventional techniques are, however, disadvantageous in that carbon itself is the irreversible capacitive component and has sites reactive to lithium, resulting in an undesirable unstability of the lithium metal on the carbon plate.

In the above circumstances, the development of a novel lithium secondary battery and a novel method of forming the same free from the above problems is desirable.

### SUMMARY OF THE INVENTION

Accordingly, it is an object of the present invention to provide a novel secondary battery having a lithium-based metal negative electrode free from the above problems.

It is a further object of the present invention to provide a novel secondary battery having a lithium-based metal negative electrode with a high surface stability which suppresses a substantial growth of dendrite thereon.

It is a still further object of the present invention to provide a novel secondary battery having a lithium-based metal negative electrode which allows the battery to have a high energy density.

It is yet a further object of the present invention to provide a novel secondary battery having a lithium-based metal negative electrode which allows the battery to have a high electromotive force.

It is further more object of the present invention to provide a novel secondary battery having a lithium-based metal negative electrode which allows the battery to exhibit desirable cyclic characteristics.

It is moreover object of the present invention to provide a novel secondary battery having a lithium-based metal negative electrode which allows the battery to have a high safety.

It is another object of the present invention to provide a novel lithium-based metal negative electrode structure for a secondary battery having a free from the above problems.

It is further another object of the present invention to provide a novel lithium-based metal negative electrode structure for a secondary battery, wherein the electrode structure provides a high surface stability which suppresses a substantial growth of dendrite thereon.

It is a still another object of the present invention to provide a novel lithium-based metal negative electrode structure for a secondary battery, wherein the electrode structure allows the battery to have a high energy density.

It is yet another object of the present invention to provide a novel lithium-based metal negative electrode structure for a secondary battery, wherein the electrode structure allows the battery to have a high electromotive force.

It is further more another object of the present invention to provide a novel lithium-based metal negative electrode structure for a secondary battery, wherein the electrode structure allows the battery to exhibit desirable cyclic characteristics.

It is moreover another object of the present invention to provide a novel lithium-based metal negative electrode structure for a secondary battery, wherein the electrode structure allows the battery to have a high safety.

It is an additional object of the present invention to provide a novel method of forming a lithium-based metal negative electrode structure for a secondary battery having a free from the above problems.

It is a further additional object of the present invention to provide a novel method of forming a secondary battery having a lithium-based metal negative electrode free from the above problems.

The present invention provides a lithium secondary battery including: a positive electrode; and a negative electrode which further includes a lamination structure comprising: a lithium ion supporting layer capable of supporting lithium ions; and an amorphous-state lithium-based layer in contact directly with the lithium ion supporting layer.

The above and other objects, features and advantages of the present invention will be apparent from the following descriptions.

### BRIEF DESCRIPTION OF THE DRAWINGS

Preferred embodiments according to the present invention will be described in detail with reference to the accompanying drawings.

FIG. 1 is a fragmentary schematic cross sectional elevation view of an illustrative embodiment of a negative electrode structure for a lithium secondary battery in a first preferred embodiment in accordance with the present invention.

FIG. 2 is a fragmentary schematic cross sectional elevation view of an illustrative embodiment of a lithium secondary battery in the first preferred embodiment in accordance with the present invention.

### DETAILED DESCRIPTION OF THE PREFERRED EMBODIMENTS

A first aspect of the present invention is a lithium secondary battery including: a positive electrode; and a negative electrode which further includes a lamination structure comprising: a lithium ion supporting layer capable of supporting lithium ions; and an amorphous-state lithium-based layer in contact directly with the lithium ion supporting layer.

It is preferable that the amorphous-state lithium-based layer comprises one selected from the groups consisting of lithium metal and lithium alloys.

It is also preferable that the lithium ion supporting layer includes at least a glass like solid state electrolyte.

It is also preferable that the lithium ion supporting layer includes at least a polymer electrolyte.

It is also preferable that the lithium ion supporting layer includes at least a carbon material.

It is also preferable that the lithium ion supporting layer includes lithium halide.

It is also preferable that the lithium ion supporting layer includes at least a porous film.

It is also preferable that the lithium ion supporting layer includes plural materials selected from the group consisting of at least a glass like solid state electrolyte, at least a polymer electrolyte, at least a carbon material, lithium halide, and at least a porous film.

It is also preferable that the lithium ion supporting layer has a thickness in the range of 0.1 micrometer to 20 micrometers.

It is also preferable that the amorphous-state lithium-based layer has a thickness in the range of 1 micrometer to 30 micrometers.

It is also preferable that the negative electrode and positive electrode are laminated with each other, so that the lithium ion supporting layer is interposed between the amorphous-state lithium-based layer and the positive layer.

It is also preferable that the negative electrode, an additional separator film and the positive electrode are laminated, so that the additional separator film is interposed between the lithium ion supporting layer and the positive layer.

A second aspect of the present invention is a negative electrode structure for a lithium secondary battery. The structure includes: a lamination structure comprising: a lithium ion supporting layer capable of supporting lithium ions; and an amorphous-state lithium-based layer in contact directly with the lithium ion supporting layer.

It is also preferable that the amorphous-state lithium-based layer comprises one selected from the groups consisting of lithium metal and lithium alloys.

It is also preferable that the lithium ion supporting layer includes at least one selected from the group consisting of at least a glass like solid state electrolyte, at least a polymer electrolyte, at least a carbon material, lithium halide, and at least a porous film.

It is also preferable that the lithium ion supporting layer has a thickness in the range of 0.1 micrometer to 20 micrometers.

It is also preferable that the amorphous-state lithium-based layer has a thickness in the range of 1 micrometer to 30 micrometers.

A third aspect of the present invention is a method of forming a negative electrode structure for a lithium secondary battery. The method comprises: forming an amorphous-state lithium-based layer in contact directly with a lithium ion supporting layer.

A fourth aspect of the present invention is a method of forming an electrode structure for a lithium secondary battery. The method comprises: forming an amorphous-state lithium-based layer in contact directly with a lithium ion supporting layer to form a negative electrode structure; and laminating the negative electrode structure with a positive electrode structure, so that the lithium ion supporting layer is interposed between the amorphous-state lithium-based layer and the lithium ion supporting layer.

A fifth aspect of the present invention is a method of forming an electrode structure for a lithium secondary battery, the method comprising: forming an amorphous-state lithium-based layer in contact directly with a lithium ion supporting layer to form a negative electrode structure; and laminating the negative electrode structure with an additional separator film and a positive electrode structure, so that the separator film is interposed between the lithium ion supporting layer and the lithium ion supporting layer.

A preferred embodiment according to the present invention will be described in detail. A lithium secondary battery is provided which has a negative electrode structure which includes at least one lithium-ion-supporting layer and an amorphous-state lithium-based metal layer on the lithium-ion-supporting layer. The lithium-based metal for the amorphous-state lithium-based metal layer may of course be lithium metal or any lithium alloy. The present inventors confirmed that the above negative electrode structure of the present invention still keeps a desirable high stability even after cyclic charge/discharge processes, namely provides desirable cyclic characteristics such as charge/discharge characteristics, and further that the above negative electrode structure of the present invention well suppresses the growth of dendrite on the surface of the negative electrode.

The present inventors also confirmed that for the lithium-ion-supporting layer, there may optionally and advantageously be available at least one of glass like solid state electrolytes, polymer solid-state electrolytes, carbon materials, lithium halide materials, and porous films solely or mixtures of at least two of them, or in complex or combination thereof.

The amorphous state lithium metal layer or the amorphous state lithium alloy layer is formed on the lithium-ion-supporting layer to form the negative electrode structure for the lithium secondary battery.

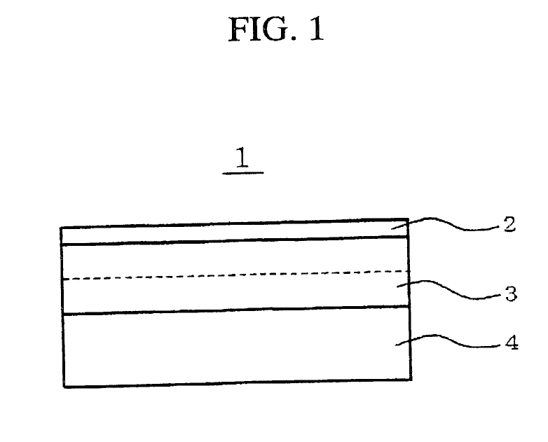

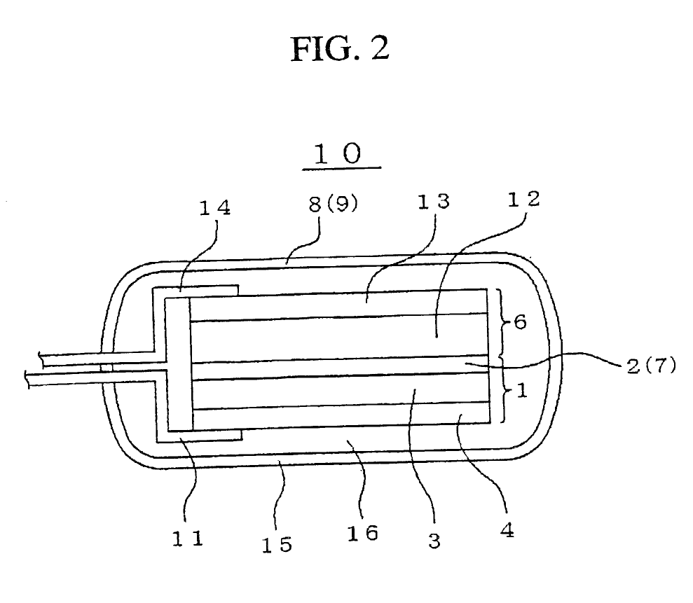

An example of the lithium secondary battery in accordance with the resent invention will hereinafter be described with reference to the drawings. FIG. 1 is a fragmentary schematic cross sectional elevation view of an illustrative preferred embodiment of a negative electrode structure for a lithium secondary battery in a first preferred embodiment in accordance with the present invention. FIG. 2 is a fragmentary schematic cross sectional elevation view of an illustrative embodiment of a lithium secondary battery in the first preferred embodiment in accordance with the present invention.

As shown in FIG. 1, an illustrative preferred embodiment of a negative electrode structure comprises a lithium-ion-supporting layer 2, an amorphous-state lithium-based metal layer 3, and a collector layer 4. The amorphous-state lithium-based metal layer 3 is in contact directly with the lithium-ion-supporting layer 2. The collector layer 4 is also in contact directly with the amorphous-state lithium-based metal layer 3. The amorphous-state lithium-based metal layer 3 may comprise either an amorphous-state lithium metal or an amorphous-state lithium alloy. The lamination structure of the amorphous-state lithium-based metal layer 3 on the lithium-ion-supporting layer 2 is essential for the present invention. The additional lamination of the collector layer 4 on the amorphous-state lithium-based metal layer 3 is optional for the present invention. The collector layer 4 provides electron conductivity.

For the lithium-ion-supporting layer 2, there may optionally and advantageously be available at least one of glass like solid state electrolytes, polymer solid-state electrolytes, carbon materials, lithium halide materials, and porous films solely or mixtures of at least two of them, or in complex or combination thereof or laminations thereof.

As the glass like solid state electrolyte for the lithium-ion-supporting layer 2, there may optionally and advantageously be selectable various oxides and various sulfides, each of which may include at least one of lithium, calcium, sodium, magnesium, beryllium, potassium, silicon, phosphorous, boron, nitrogen, aluminum, and various transition metals. Typical examples are SiO₂, Li₃PO₄, B₂O₃, P₂S₅, P₂O₅, LiSO₄, LiₓPO_{y}N_{z}, and Li₂O, and mixtures or complexes thereof. Particularly preferable examples are Li₂O, SiO₂, P₂O₅, and LiₓPO_{y}N_{z}.

As the polymer solid-state electrolyte for the lithium-ion-supporting layer 2, there may optionally and advantageously be selectable polyethylene oxide (PEO), polypropylene oxide (PPO), polyvinylidene fluoride (PVDF), polyacrylonitrile (PAN), and derivatives thereof.

As the carbon material for the lithium-ion-supporting layer 2, there may optionally and advantageously be selectable diamond-like carbon, graphite, amorphous carbon, and carbon nanotubes. Diamond-like carbon and graphite are particularly preferable.

As the lithium halide for the lithium-ion-supporting layer 2, there may optionally and advantageously be selectable lithium fluoride, lithium chloride, lithium bromide, and lithium iodide. Lithium fluoride is particularly preferable.

As the porous film for the lithium-ion-supporting layer 2, there may optionally and advantageously be selectable a single or multiple layers of nonwoven fabric or polyolefin porous films such as polyethylene or polypropylene. Polyethylene porous film is particularly preferable.

A preferable thickness of the lithium-ion-supporting layer 2 may be ranged from 0.1 micrometer to 20 micrometers. If the thickness of the lithium-ion-supporting layer 2 is less than 0.1 micrometer, then the lithium-ion-supporting layer 2 has an insufficient capability of supporting lithium ions. If the thickness of the lithium-ion-supporting layer 2 is more than 20 micrometers, then this results in a large resistance of the negative electrode.

As described above, the amorphous-state lithium-based metal layer 3 of either the amorphous-state lithium metal or the amorphous-state lithium alloy is formed on the lithium-ion-supporting layer 2. A preferable thickness of the amorphous-state lithium-based metal layer 3 may be ranged from 1 micrometer to 30 micrometers. If the thickness of the amorphous-state lithium-based metal layer 3 is less than 1 micrometer, then the quantity of the lithium metal as active material of the negative electrode is insufficient. If the thickness of the amorphous-state lithium-based metal layer 3 is more than 30 micrometers, then this makes it difficult to obtain a desirable uniformity in lithium-ion distribution of the amorphous-state lithium-based layer 3. In other words, if the thickness of the amorphous-state lithium-based metal layer 3 is within the above desirable range from 1 micrometer to 30 micrometers, then this means that the quantity of the lithium metal as active material of the negative electrode is sufficient, and that the amorphous-state lithium-based layer 3 may have a desirable uniformity in lithium-ion distribution.

The amorphous-state lithium-based metal layer 3 may optionally and advantageously be formed by any available method, typically, a melt solution cooling method, a liquid rapid cooling method, an atomize method, a vacuum evaporation method, a sputtering method, a plasma enhanced chemical vapor deposition method, a light chemical vapor deposition method, and a thermal chemical vapor deposition method.

The lithium alloy for the amorphous-state lithium-based metal layer 3 may be binary, ternary, or quaternary alloy or multi-system alloys. Typical examples of a metal or metals which may form the alloy with lithium are Al, Si, Ag, Te, Pb, Sn, In, Cd, Bi, Ba, Ca, Pt, Mg, Zn, La and Eu.

The negative electrode 1 which comprises the amorphous lithium metal layer or the amorphous lithium alloy layer 3 on the lithium ion supporting layer 2, ensures the improved uniformity of the lithium ion distribution on the active material surface.

Particularly, each of the glass like solid state electrolytes, the polymer solid-state electrolytes, the carbon materials, lithium halide, and the porous films is superior in supporting lithium ions and highly stable physically and chemically. This contributes to suppress the undesirable growth of the dendrite from the lithium metal surface during the charge/discharge processes and also to improve the cycle efficiency and life-time of the battery.

Further, as described above, the active lithium metal surface is covered by the lithium ion supporting layer which is inactive. This inactive lithium ion supporting layer is advantageous and effective to suppress an undesirable reaction of lithium metal or lithium alloy with moisture which may be entered or introduced by various materials for the electrolyte, the positive electrode and the separator in the process for assembling the battery.

After the above-described negative electrode 1 has been formed by the above-described methods, then a lithium secondary battery 10 may be assembled by known techniques from the improved negative electrode 1, the electrolyte layer and the positive electrode 6. The electrolyte layer may be either solid-state or liquid-state.

In details, the amorphous lithium metal layer 3 or the amorphous lithium alloy layer 3 may be formed on the lithium ion supporting layer 2 by selected one from the available known methods such as the vacuum evaporation methods, the sputtering methods, and the chemical vapor deposition methods to form the negative electrode 1. Separately, the positive electrode 6 is also formed.

The negative electrode 1 and the positive electrode 6 may optionally and advantageously be combined so that the lithium ion supporting layer 2 is in contact directly with the positive electrode 6 and the lithium ion supporting layer 2 acts as the separator for separating the amorphous lithium metal layer 3 or the amorphous lithium alloy layer 3 from the positive electrode 6.

Alternatively, it is also optionally and advantageously be possible that an additional separator 7 is interposed between the negative electrode 1 and the positive electrode 6, so that the lithium ion supporting layer 2 is in contact directly with the interposed separator 7 and is separated by the interposed separator 7 from the positive electrode 6, whereby the amorphous lithium metal layer 3 or the amorphous lithium alloy layer 3 is separated by both the lithium ion supporting layer 2 and the interposed separator 7 from the positive electrode 6.

Optionally and advantageously, the above-described negative electrode may further include the collector layer 4 which is in contact with the amorphous lithium metal layer 3 or the amorphous lithium alloy layer 3 as shown in FIG. 1.

The positive electrode 6 may be formed by applying, onto a substrate or a base layer, a mixture of a complex oxide, an electrically conductive material, a binding material, and a solvent. The complex oxide may typically be represented by LiₓMO₂, where “M” represents at least one transition metal. For example, preferable examples of the complex oxide may be LiₓCoO₂, LiₓNiO₂, LiₓMn₂O₄, LiₓMnO₃, and LiₓNi_{y}C_{1-y}O₂. A preferable example of the electrically conductive material may typically be carbon black. A preferable example of the binder may be PVDF. A preferable example of the solvent is N-methyl-2-pyrolidone (NMP). A preferable example of the substrate or the base layer may be an aluminum foil.

If the additional separator 7 is interposed between the negative and positive electrodes 1 and 6, then the separator 7 may optionally and advantageously comprise selected one of various porous films of poly-olefins such as polypropylene and polyethylene, and fluorine resins. In the negative electrode 1, the lithium ion supporting layer 2 may be hydrophobic.

In a dried air or an inert gas atmosphere, laminations of the lithium ion supporting layer 2, the separator 7 and the amorphous lithium metal layer 3 or the amorphous lithium alloy layer 3 may be formed and contained in a battery case 8. Alternatively, the laminations may further be rolled to a cylindrically shaped battery element and then contained into the battery case 8. Sealing the battery case 8 may optionally and advantageously be made by using a flexible film 9 which may comprise laminations of a synthetic resin and a metal foil, thereby to produce the battery 10.

The electrolyte to be used for the battery may be either electrolytic solutions or polymer electrolytes. The electrolytic solution may be prepared by dissolution of a lithium salt into an organic solvent. Preferable examples of the electrolytic solution are propylene carbonate (PC), ethylene carbonate (EC), dimethyl carbonate (DMC), and diethyl carbonate (DEC). Preferable examples of lithium salt are LiPF₆, LiBF₄, lithium imide salt, and lithium methide salt.

One preferable example of the available methods for forming the lithium secondary battery in accordance with the present invention is as follows. A lithium ion supporting layer is prepared, which comprises at least one selected from the groups consisting of glass like solid state electrolytes, polymer solid-state electrolytes, carbon materials, lithium halide, and porous films. Either one of the amorphous lithium metal film or the amorphous lithium alloy film is formed on the surface of the lithium ion supporting layer to form the negative electrode. The positive electrode is also prepared in the known available method separately from the formation of the negative electrode. The negative electrode and the positive electrode are laminated and contained together with the electrolyte in the battery case to form the lithium secondary battery.

Another preferable example of the available methods for forming the lithium secondary battery in accordance with the present invention is as follows. A lithium ion supporting layer is prepared, which comprises at least one selected from the groups consisting of glass like solid state electrolytes, polymer solid-state electrolytes, carbon materials, lithium halide, and porous films. Either one of the amorphous lithium metal film or the amorphous lithium alloy film is formed on the surface of the lithium ion supporting layer to form the negative electrode. The positive electrode and the separator are also prepared in the known available method separately from the formation of the negative electrode. The negative electrode, the separator and the positive electrode are laminated and contained together with the electrolyte in the battery case to form the lithium secondary battery.

The preferable examples of the method of forming the lithium secondary battery in accordance with the present invention will be described in more details.

### EXAMPLE 1

(Formation of the Negative Electrode 1)

A lithium ion supporting layer 2 was prepared, which comprises a polyethylene porous film with a square shape of 50 mm by 50 mm and a thickness of 10 micrometers. The lithium ion supporting layer 2 was placed as a substrate in a chamber of a vacuum evaporation system. A pressure in the chamber of the vacuum evaporation system was reduced to a vacuum of 1E-5 Pa. Lithium was evaporated with an electron beam irradiation in order to form an amorphous lithium metal layer 3 having a thickness of 2 micrometers on the lithium ion supporting layer 2, thereby forming a first lamination structure.

In the same manner as described above, a lithium-evaporated layer 3′ was formed by a resistance heating method on a collector 4 which comprises a copper foil, thereby forming a second lamination structure.

The first and second lamination structures were combined or bonded with each other at room temperature, wherein the amorphous lithium metal layer 3 and the lithium-evaporated layer 3′ were in contact directly with each other, so that the amorphous lithium metal layer 3 and the lithium-evaporated layer 3′ were interposed between the collector 4 and the lithium ion supporting layer 2, resulting in a formation of the negative electrode 1 with the above-described lamination structure shown in FIG. 1.

The negative electrode 1 was cut to define a size of 45 mm by 40 mm. A nickel tub 11 was welded to the negative electrode 1.

(Formation of the Positive Electrode 6)

LiₓMn₂O₄ was mixed with carbon black and PVDF, and further dispersed and mixed into NMP as a solvent to prepare a positive electrode material. This positive electrode material was applied on one surface of an aluminum foil 13 and then dried to form an applied layer 12 having a thickness of 130 micrometers on the aluminum foil 13, thereby forming a positive electrode 6. A lead 14 was bonded to the positive electrode 6.

(Formation of Lithium Secondary Battery)

The above negative electrode 1, the positive electrode 6 and the separator 7 were laminated, so that the separator 7 be interposed between the negative electrode 1 and the positive electrode 6, thereby to form a laminated battery element. Alternatively, the above negative electrode 1 and the positive electrode 6 were laminated, wherein the lithium ion supporting layer 2 of the negative electrode 1 is in contact directly with the positive electrode 6, thereby to form a laminated battery element. A polypropylene film is laminated on a first surface of an aluminum foil, while a nylon film is laminated on a second surface of the aluminum foil, thereby to form a laminate film 15. The laminated battery element is coated with the laminate film 15.

A solvent comprising a mixture of EC and DEC was prepared. 1 mol/L of LiN(C₂F₅SO₂)₂ was dissolved into the solvent, thereby to prepare an electrolytic solution 16. This electrolytic solution 16 was injected into the laminate film 15 to fill the electrolytic solution 16 into between the laminated battery element and the laminate film 15, thereby to form a lithium secondary battery 10.

(Charge/Discharge Test)

Charge/discharge tests were made to the lithium secondary battery 10 at a temperature of 20° C., a charge rate of 0.1C, a discharge rate of 0.2C, a charge voltage of 4.3V, a discharge voltage of 3.0V, and a discharge of depth of 30%.

An averaged cyclic efficiency E(%) was calculated from the charge/discharge characteristic by use of the following equation:

E=(Q−Qex/(n−1))/Q

where “Q” represents the charge capacity (Ah/g), “Qex” represents the excess mount of lithium metal (Ah/g), “n” represents the number of cycles having needed for consuming the excess mount of lithium metal, wherein if the charge capacity becomes reduced to 80% of the charge capacity in the first cycle.

The results of the cycle tests (the charge/discharge tests) were shown on the below Table 1. The averaged cyclic efficiency E(%) of the lithium secondary battery in Example 1 was 95.0%.

### COMPARATIVE EXAMPLE 1

The lithium secondary battery was prepared in the same manner as the above EXAMPLE 1, except that no lithium ion supporting layer is provided, and the negative electrode comprises a lithium metal film prepared by rolling lithium metal.

Comparision in Cyclic Efficiency

It was confirmed that the secondary batter of Example 1 shows the averaged cyclic efficiency E(%) of 95.0%, while the secondary batter of Comparative Example 1 shows the averaged cyclic efficiency E(%) of 67.7%. The averaged cyclic efficiency E(%) of 95.0% in Example 1 was much higher than the averaged cyclic efficiency E(%) of 67.7% in Comparative Example 1. This demonstrates that the lithium ion supporting layer in contact directly with the amorphous lithium metal or alloy layer contributes to improve the averaged cyclic efficiency.

Namely, it was also confirmed that the lithium ion supporting layer 2 is capable of ensuring a desirable uniformity of ion concentration on the surface of the lithium metal or alloy, and also preventing a localization of the lithium discharge or a growth of the dendrite.

Further, as described above, the lithium metal or alloy layer 3, which is in contact directly with the lithium ion supporting layer 2, is in the amorphous state. This amorphous state of the lithium metal or alloy layer 3 is likely to exhibit no deterioration in uniformity such as no crystal grain nor crystal defect. This amorphous state of the lithium metal or alloy layer 3 enhances the desirable effect of the lithium ion supporting layer 2.

Lithium metal or alloy itself is incapable of supporting lithium ions. Further, the rolled lithium metal film is polycrystal, and includes crystal grains and crystal defects, which causes an undesirable non-uniformity of the lithium ions on the surface of the lithium metal or alloy. This non-uniformity of the lithium ions on the surface of the lithium metal or alloy allows localization of the lithium discharge or the growth of the dendrite, whereby the cyclic lifetime or the cyclic characteristics are deteriorated.

As described above, in accordance with the present invention, the lithium ion supporting layer 2 of polyethylene porous film in contact directly with the amorphous state lithium metal or alloy layer 3 is capable of supporting lithium ions and ensuring the desirable high uniformity of lithium ions on the surface of the lithium metal or alloy layer 3. This high uniformity of the lithium ions on the surface of the lithium metal or alloy prevents any localization of the lithium discharge or any growth of the dendrite, whereby the cyclic lifetime or the cyclic characteristics are improved.

### EXAMPLE 2

The lithium secondary battery was prepared in the same manner as the above EXAMPLE 1, except that the lithium ion supporting layer 2 comprises lithium fluoride (LiF) in place of polyethylene. The averaged cyclic efficiency E(%) of the lithium secondary battery in Example 2 was 98.5%, which is higher than that in, Example 1. The lithium ion supporting layer 2 of polyethylene porous film in contact directly with the amorphous state lithium metal or alloy layer 3 is capable of supporting lithium ions and ensuring the desirable high uniformity of lithium ions on the surface of the lithium metal or alloy layer 3. This high uniformity of the lithium ions on the surface of the lithium metal or alloy prevents any localization of the lithium discharge or any growth of the dendrite, whereby the cyclic lifetime or the cyclic characteristics are improved.

### COMPARATIVE EXAMPLE 2

The lithium secondary battery was prepared in the same manner as the above EXAMPLE 1, except that the lithium metal film in the non-amorphous state was prepared by rolling lithium metal. The averaged cyclic efficiency E(%) of the lithium secondary battery in Comparative Example 2 was 92.8%.

Comparision in Cyclic Efficiency

It was confirmed that the secondary batter of Example 1 shows the averaged cyclic efficiency E(%) of 95.0%, while the secondary batter of Comparative Example 2 shows the averaged cyclic efficiency E(%) of 92.8%. The averaged cyclic efficiency E(%) of 95.0% in Example 1 was slightly higher than the averaged cyclic efficiency E(%) of 92.8% in Comparative Example 2. This demonstrates that the amorphous state of the lithium metal or alloy layer 3 in contact directly with the lithium ion supporting layer 2 contributes to improve the averaged cyclic efficiency or enhances the above effect provided by the lithium ion supporting layer 2.

### EXAMPLE 3

The lithium secondary battery was prepared in the same manner as the above EXAMPLE 1, except that the lithium ion supporting layer 2 comprises polyvinylidene fluoride (PVDF) in place of polyethylene. The averaged cyclic efficiency E(%) of the lithium secondary battery in Example 3 was 98.7%, which is higher than that in Example 1. The lithium ion supporting layer 2 of polyvinylidene fluoride (PVDF) in contact directly with the amorphous state lithium metal or alloy layer 3 is capable of supporting lithium ions and ensuring the desirable high uniformity of lithium ions on the surface of the lithium metal or alloy layer 3. This high uniformity of the lithium ions on the surface of the lithium metal or alloy prevents any localization of the lithium discharge or any growth of the dendrite, whereby the cyclic lifetime or the cyclic characteristics are improved.

### COMPARATIVE EXAMPLE 3

The lithium secondary battery was prepared in the same manner as the above EXAMPLE 2, except that the lithium metal film in the non-amorphous state was prepared by rolling lithium metal. The averaged cyclic efficiency E(%) of the lithium secondary battery in Comparative Example 3 was 96.6%.

Comparision in Cyclic Efficiency

It was confirmed that the secondary batter of Example 2 shows the averaged cyclic efficiency E(%) of 98.5%, while the secondary batter of Comparative Example 3 shows the averaged cyclic efficiency E(%) of 96.6%. The averaged cyclic efficiency E(%) of 98.5% in Example 2 was slightly higher than the averaged cyclic efficiency E(%) of 96.6% in Comparative Example 3. This demonstrates that the amorphous state of the lithium metal or alloy layer 3 in contact directly with the lithium ion supporting layer 2 contributes to improve the averaged cyclic efficiency or enhances the above effect provided by the lithium ion supporting layer 2.

### EXAMPLE 4

The lithium secondary battery was prepared in the same manner as the above EXAMPLE 1, except that the lithium ion supporting layer 2 comprises diamond-like carbon (DLC) in place of polyethylene. The averaged cyclic efficiency E(%) of the lithium secondary battery in Example 4 was 98.8%, which is higher than that in Example 1. The lithium ion supporting layer 2 of diamond-like carbon (DLC) in contact directly with the amorphous state lithium metal or alloy layer 3 is capable of supporting lithium ions and ensuring the desirable high uniformity of lithium ions on the surface of the lithium metal or alloy layer 3. This high uniformity of the lithium ions on the surface of the lithium metal or alloy prevents any localization of the lithium discharge or any growth of the dendrite, whereby the cyclic lifetime or the cyclic characteristics are improved.

### COMPARATIVE EXAMPLE 4

The lithium secondary battery was prepared in the same manner as the above EXAMPLE 3, except that the lithium metal film in the non-amorphous state was prepared by rolling lithium metal. The averaged cyclic efficiency E(%) of the lithium secondary battery in Comparative Example 4 was 96.8%.

Comparision in Cyclic Efficiency

It was confirmed that the secondary batter of Example 3 shows the averaged cyclic efficiency E(%) of 98.7%, while the secondary batter of Comparative Example 4 shows the averaged cyclic efficiency E(%) of 96.8%. The averaged cyclic efficiency E(%) of 98.7% in Example 3 was slightly higher than the averaged cyclic efficiency E(%) of 96.8% in Comparative Example 4. This demonstrates that the amorphous state of the lithium metal or alloy layer 3 in contact directly with the lithium ion supporting layer 2 contributes to improve the averaged cyclic efficiency or enhances the above effect provided by the lithium ion supporting layer 2.

### EXAMPLE 5

The lithium secondary battery was prepared in the same manner as the above EXAMPLE 1, except that the lithium ion supporting layer 2 comprises SiO₂-Li₂O-P₂S₅ in place of polyethylene. The averaged cyclic efficiency E(%) of the lithium secondary battery in Example 5 was 98.6%, which is higher than that in Example 1. The lithium ion supporting layer 2 of SiO₂-Li₂O-P₂S₅ in contact directly with the amorphous state lithium metal or alloy layer 3 is capable of supporting lithium ions and ensuring the desirable high uniformity of lithium ions on the surface of the lithium metal or alloy layer 3. This high uniformity of the lithium ions on the surface of the lithium metal or alloy prevents any localization of the lithium discharge or any growth of the dendrite, whereby the cyclic lifetime or the cyclic characteristics are improved.

### COMPARATIVE EXAMPLE 5

The lithium secondary battery was prepared in the same manner as the above EXAMPLE 4, except that the lithium metal film in the non-amorphous state was prepared by rolling lithium metal. The averaged cyclic efficiency E(%) of the lithium secondary battery in Comparative Example 5 was 96.9%.

Comparision in Cyclic Efficiency

It was confirmed that the secondary batter of Example 4 shows the averaged cyclic efficiency E(%) of 98.8%, while the secondary batter of Comparative Example 5 shows the averaged cyclic efficiency E(%) of 96.9%. The averaged cyclic efficiency E(%) of 98.8% in Example 4 was slightly higher than the averaged cyclic efficiency E(%) of 96.9% in Comparative Example 5. This demonstrates that the amorphous state of the lithium metal or alloy layer 3 in contact directly with the lithium ion supporting layer 2 contributes to improve the averaged cyclic efficiency or enhances the above effect provided by the lithium ion supporting layer 2.

### COMPARATIVE EXAMPLE 6

The lithium secondary battery was prepared in the same manner as the above EXAMPLE 5, except that the lithium metal film in the non-amorphous state was prepared by rolling lithium metal. The averaged cyclic efficiency E(%) of the lithium secondary battery in Comparative Example 6 was 97.1%.

Comparision in Cyclic Efficiency

It was confirmed that the secondary batter of Example 5 shows the averaged cyclic efficiency E(%) of 98.6%, while the secondary batter of Comparative Example 6 shows the averaged cyclic efficiency E(%) of 97.1%. The averaged cyclic efficiency E(%) of 98.6% in Example 5 was slightly higher than the averaged cyclic efficiency E(%) of 97.1% in Comparative Example 6. This demonstrates that the amorphous state of the lithium metal or alloy layer 3 in contact directly with the lithium ion supporting layer 2 contributes to improve the averaged cyclic efficiency or enhances the above effect provided by the lithium ion supporting layer 2.

TABLE 1

| | Ex. 1 | Ex. 2 | Ex. 3 | Ex. 4. | Ex. 5 |
|---|---|---|---|---|---|
| (SL) | PE | LiF | PVDF | DLC | SiO₂—Li₂O—P₂S₅ |
| E(%) | 95.0 | 98.5 | 98.7 | 98.8 | 98.6 |

“SL” represents the lithium ion supporting layer, “PE” represents the polyethylene porous film, and “E” represents the averaged cyclic efficiency (%).

TABLE 2

| | Com.Ex. 1 | Com.Ex. 2 | Com.Ex. 3 | Com.Ex. 4. | Com.Ex. 5 | Cpm.Ex6 |
|---|---|---|---|---|---|---|
| (SL) | | PE | LiF | PVDF | DLC | SiO₂—Li₂O—P₂ S₅ |
| E(%) | 67.7 | 92.8 | 96.6 | 96.8 | 96.9 | 97.1 |

“SL” represents the lithium ion supporting layer, “PE” represents the polyethylene porous film, and “E” represents the averaged cyclic efficiency (%).

Although the invention has been described above in connection with several preferred embodiments therefor, it will be appreciated that those embodiments have been provided solely for illustrating the invention, and not in a limiting sense. Numerous modifications and substitutions of equivalent materials and techniques will be readily apparent to those skilled in the art after reading the present application, and all such modifications and substitutions are expressly understood to fall within the true scope and spirit of the appended claims.

What is claimed is:

1. A lithium secondary battery including:
a positive electrode; and
a negative electrode which further includes a lamination structure comprising:
a lithium ion supporting layer capable of supporting lithium ions; and
an amorphous-state lithium-based layer in contact directly with said lithium ion supporting layer.

2. The lithium secondary battery as claimed in claim 1, wherein said amorphous-state lithium-based layer comprises one selected from the groups consisting of lithium metal and lithium alloys.

3. The lithium secondary battery as claimed in claim 1, wherein said lithium ion supporting layer includes at least a glass like solid state electrolyte.

4. The lithium secondary battery as claimed in claim 1, wherein said lithium ion supporting layer includes at least a polymer electrolyte.

5. The lithium secondary battery as claimed in claim 1, wherein said lithium ion supporting layer includes at least a carbon material.

6. The lithium secondary battery as claimed in claim 1, wherein said lithium ion supporting layer includes lithium halide.

7. The lithium secondary battery as claimed in claim 1, wherein said lithium ion supporting layer includes at least a porous film.

8. The lithium secondary battery as claimed in claim 1, wherein said lithium ion supporting layer includes plural materials selected from the group consisting of at least a glass like solid state electrolyte, at least a polymer electrolyte, at least a carbon material, lithium halide, and at least a porous film.

9. The lithium secondary battery as claimed in claim 1, wherein said lithium ion supporting layer has a thickness in the range of 0.1 micrometer to 20 micrometers.

10. The lithium secondary battery as claimed in claim 1, wherein said amorphous-state lithium-based layer has a thickness in the range of 1 micrometer to 30 micrometers.

11. The lithium secondary battery as claimed in claim 1, wherein said negative electrode and positive electrode are laminated with each other, so that said lithium ion supporting layer is interposed between said amorphous-state lithium-based layer and said positive electrode.

12. The lithium secondary battery as claimed in claim 1, wherein said negative electrode, an additional separator film and said positive electrode are laminated, so that said additional separator film is interposed between said lithium ion supporting layer and said positive electrode.

13. A negative electrode structure for a lithium secondary battery, said structure including: a lamination structure comprising:
a lithium ion supporting layer capable of supporting lithium ions; and
an amorphous-state lithium-based layer in contact directly with said lithium ion supporting layer.

14. The negative electrode structure as claimed in claim 13, wherein said amorphous-state lithium-based layer comprises one selected from the groups consisting of lithium metal and lithium alloys.

15. The negative electrode structure as claimed in claim 13, wherein said lithium ion supporting layer includes at least one selected from the group consisting of at least a glass like solid state electrolyte, at least a polymer electrolyte, at least a carbon material, lithium halide, and at least a porous film.

16. The negative electrode structure as claimed in claim 13, wherein said lithium ion supporting layer has a thickness in the range of 0.1 micrometer to 20 micrometers.

17. The negative electrode structure as claimed in claim 13, wherein said amorphous-state lithium-based layer has a thickness in the range of 1 micrometer to 30 micrometers.

18. A method of forming a negative electrode structure for a lithium secondary battery, said method comprising:
forming an amorphous-state lithium-based layer in contact directly with a lithium ion supporting layer.

19. A method of forming an electrode structure for a lithium secondary battery, said method comprising:
forming an amorphous-state lithium-based layer in contact directly with a lithium ion supporting layer to form a negative electrode structure; and
laminating said negative electrode structure with a positive electrode structure, so that said lithium ion supporting layer is interposed between said amorphous-state lithium-based layer and said positive electrode.

20. A method of forming an electrode structure for a lithium secondary battery, said method comprising:
forming an amorphous-state lithium-based layer in contact directly with a lithium ion supporting layer to form a negative electrode structure; and
laminating said negative electrode structure with an additional separator film and a positive electrode structure, so that said separator film is interposed between said lithium ion supporting layer and said positive electrode.
